(19) United States
(12) Patent Application Publication
(10) Pub. No.: US 2015/0067491 A1
(43) Pub. Date: Mar. 5, 2015

(54) INTELLIGENT AUTO COMPLETE

(71) Applicant: International Business Machines Corporation, Armonk, NY (US)

(72) Inventors: Ramakrishnan Rajamony, Austin, TX (US); William Evan Speight, Austin, TX (US); Mark William Stephenson, Austin, TX (US)

(73) Assignee: International Business Machines Corporation, Armonk, NY (US)

(21) Appl. No.: 14/017,034

(22) Filed: Sep. 3, 2013

Related U.S. Application Data
(63) Continuation of application No. 14/016,756, filed on Sep. 3, 2013.

(51) Int. Cl. G06F 17/24

(52) U.S. Cl. CPC G06F 17/24
USPC 715/271

(57) ABSTRACT

A method includes incorporating a local service within a user's device, accessing at least one external service via the user's device; starting a service request for the at least one external service from an input area of the user's device, causing the local service to determine at least one possible completion for the service request based on the input to the at least one external service, and providing the at least one possible completion to the input area of the user's device, wherein the local service consults at least one user context before providing the at least one possible completion to the input area of the user's device.

### CROSS-REFERENCE TO RELATED APPLICATION

This application is a continuation application of U.S. patent application Ser. No. 14/016,756, “INTELLIGENT AUTO COMPLETE”, filed on Sep. 3, 2013, and is assigned to the same assignee in the present application, contents of which are incorporated by reference herein in its entirety.

### BACKGROUND

The present invention relates to intelligent auto complete for user's devices, and more specifically, to auto completing an input section of the user's device based upon a user context.

### SUMMARY

According to one aspect of the present invention a method includes: incorporating a local service within a user's device; accessing at least one external service via the user's device; starting a service request for the at least one external service from an input area of the user's device; causing the local service to determine at least one possible completion for the service request based on the input to the at least one external service; and providing the at least one possible completion to the input area of the user's device, wherein the local service consults at least one user context before providing the at least one possible completion to the input area of the user's device.

According to another aspect of the present invention a computer system includes one or more processors, one or more computer-readable memories and one or more computer-readable, tangible storage devices; a local service module operatively coupled to at least one of the one or more storage devices for execution by at least one of the one or more processors via at least one of the one or more memories, configured to start a service request for at least one external service from an input area of a user's device; and the local service module operatively coupled to at least one of the one or more storage devices for execution by at least one of the one or more processors via at least one of the one or more memories, is further configured to determine at least one possible completion for the service request based on the started service request to the at least one external service, wherein the local service module consults at least one user context before providing the at least one possible completion to the input area of the user's device.

According to still yet another aspect of the present invention a computer program product includes: one or more computer-readable, tangible storage medium; program instructions, stored on at least one of the one or more storage medium, to incorporate a local service within a user's device; program instructions, stored on at least one of the one or more storage medium, to access at least one external service via the user's device; program instructions, stored on at least one of the one or more storage medium, to start a service request for the at least one external service from an input area of the user's device; program instructions, stored on at least one of the one or more storage medium, to cause the local service to determine at least one possible completion for the service request based on the input to the at least one external service; and program instructions, stored on at least one of the one or more storage medium, to provide the at least one possible completion to the input area of the user's device, wherein the local service consults at least one user context before providing the at least one possible completion to the input area of the user's device.

### BRIEF DESCRIPTION OF THE SEVERAL VIEWS OF THE DRAWINGS

FIG. 1 shows a flowchart according to an embodiment of the present invention.

FIG. 2 shows another flowchart according to an embodiment of the present invention.

FIG. 3 shows a flowchart according to an embodiment of the present invention.

FIG. 4 shows an exemplary implementation according to an embodiment of the present invention.

FIG. 5 shows another exemplary implementation according to an embodiment of the present invention.

FIG. 6 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

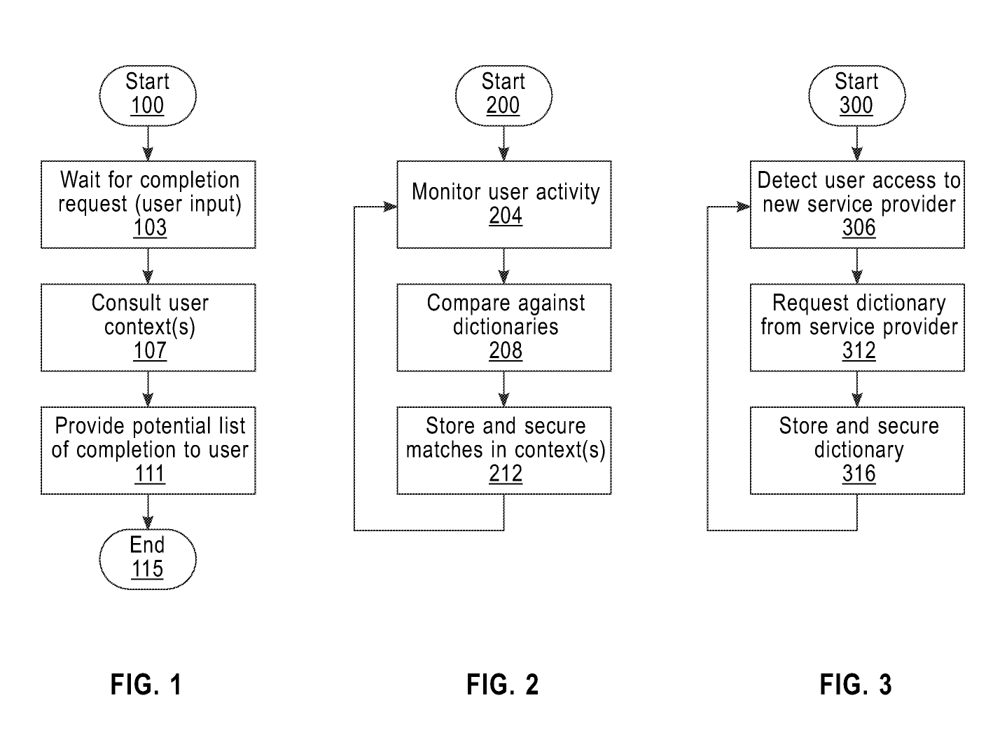

Referring to FIG. 1, there exists a need to allow user devices to seek completion of input inquiries while keeping the user's data confidential from service providers. A user's device local process according an embodiment of the present invention starts (100) by waiting for a service request input from a user's device (103). It should be noted that a variety user devices have the capability of submitting a service request. These devices may include, but are not limited to, smart phones, laptops, personal computers, televisions or any other wired/wireless communication device. Once a user starts inputting information into a device for requesting service from a service provider, the process consults the user's context (107). An user's context can include previous input inquires, match results to service providers dictionaries (which will be further described with reference to FIGS. 2, 3 and 5), personal information, location, type of device, etc. The user's context is never shared with the service providers. The user's context can be stored and secured on the user's device or on a remote server. In the case of the storing the user's context remotely, a context manager can implemented. The context manager could manage and secure a plurality of users context. Once the process has consulted the user's context (107), the process is capable of providing a potential list of completed input inquiries to the user (111) for requesting services from a service provider.

Referring to FIG. 2, a first sub-process (200) according to an embodiment of the invention is directed to developing a user's context. The process monitors the user's activity (204) as the user uses their electronic device. The monitoring may include requesting services from service providers. As part of that request, the service provider provides their service dictionary to the local process within the user's device. Once the dictionaries have been provided, they are compared to the against the user's activity (208). The process then stores and secures the user's context (212), with the matched context(s), within the user's device. This process continually repeats to make sure the stored context(s) are up to date.

Referring to FIG. 3, another sub-process (300) according to an embodiment of the invention is directed to detecting new service providers. The process detects when a user sends a service request to a service provider (306). If the service provider is new, the process sends a request for the service provider's dictionary (312). Once the dictionary is received it is stored and secured (316) within the user's device. The process continually repeats to make sure any service requests to new service providers that the dictionary for service provider is obtained. It should be noted while an embodiment of the present invention refers to service providers dictionaries, other service request definitions by the service provider can be received. Dictionaries can also be received incrementally to limit the amount of information being sent and received. Dictionary updates could also be pushed to the client as they get updated on the service provider end.

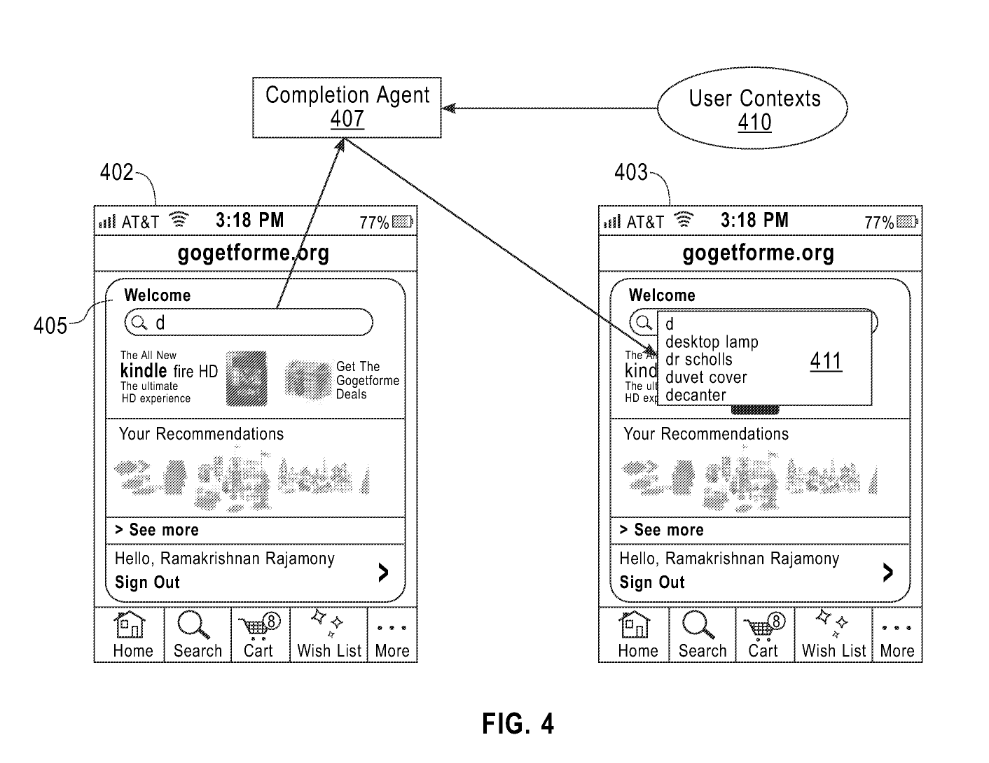

Referring to FIG. 4, a first exemplary embodiment of the present invention is depicted. A user device includes a first display 402 having a service request input area 405. The local service, residing in the user's device, includes both a completion agent 407 and a user context 410. Once the user begins to fill out the input area 405, the completion agent 407 receives the user's context to assist in suggesting filling out the input area 411 of the second display 403. As previously mentioned regarding the process, the completion agent 407 suggests the most intelligent auto results regarding possible service requests for the service provider. The user then has the opportunity to select the best service request for that particular service provider.

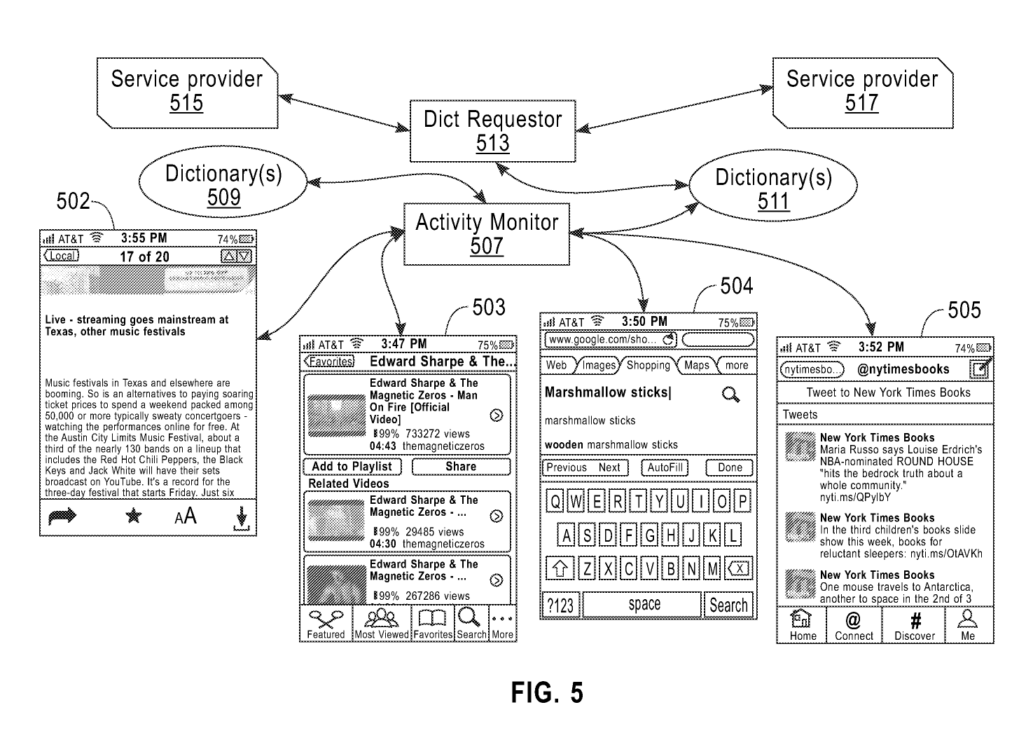

Referring to FIG. 5, another exemplary embodiment of the present invention is depicted. Typical user devices have the capability of having several displays in operation. One embodiment of the present invention includes a user device having displays (502, 503, 504 and 505) in use. The user's device has a local service according to the present invention. The local service includes an activity monitor 507, stored context(s) 509, stored service provider's dictionary(s) 511 and dictionary requestor 513. The activity monitor 507 monitors each of the open displays (502, 503, 504 and 505). The monitor 507 sees that window display 504 is in the process of requesting a service request via the input area 510. The activity monitor 507 then obtains the user's context and any necessary service provider dictionary(s) 511. Once the user's context 509 has been received by the activity monitor 507 it supplies an intelligent auto completion to the input area 510 for requesting a service. If the needed dictionary is currently not stored in the dictionary database 511, a dictionary requestor 513 sends a request to the service providers (515, 517).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

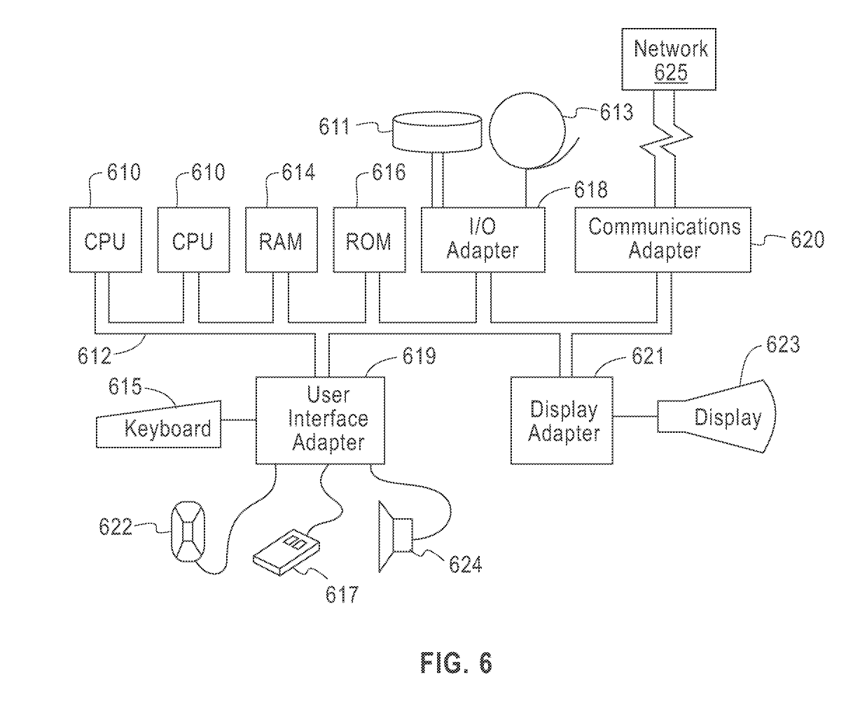

Referring now to FIG. 6, this schematic drawing illustrates a hardware configuration of an information handling/computer system in accordance with the embodiments of the invention. The system comprises at least one processor or central processing unit (CPU) 610. The CPUs 610 are interconnected via system bus 612 to various devices such as a random access memory (RAM) 614, read-only memory (ROM) 616, and an input/output (I/O) adapter 618. The I/O adapter 618 can connect to peripheral devices, such as disk units 611 and tape drives 613, or other program storage devices that are readable by the system. The system can read the inventive instructions on the program storage devices and follow these instructions to execute the methodology of the embodiments of the invention. The system further includes a user interface adapter 619 that connects a keyboard 615, mouse 617, speaker 624, microphone 622, and/or other user interface devices such as a touch screen device (not shown) to the bus 612 to gather user input. Additionally, a communication adapter 620 connects the bus 612 to a data processing network 625, and a display adapter 621 connects the bus 612 to a display device 623 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
incorporating a local service within a user's device;
accessing at least one external service via the user's device;
starting a service request for the at least one external service from an input area of the user's device;
causing the local service to determine at least one possible completion for the service request based on the input to the at least one external service; and
providing the at least one possible completion to the input area of the user's device, wherein the local service consults at least one user context before providing the at least one possible completion to the input area of the user's device.

2. The method according to claim 1, wherein the local service has access to the user's device history of service requests and consults the history of service requests before providing the at least one possible completion to the input area of the user's device.

3. The method according to claim 1, wherein the local service receives and stores at least one dictionary from the at least one external service.

4. The method according to claim 3, wherein the local service compares the stored at least one dictionary from the at least one external service, the at least one user context and saves any matches as part of a user context.

5. The method according to claim 1, further comprising securing information the local service uses and receives to the user's device use only.

6. The method according to claim 4, wherein the local service continually updates the stored at least one dictionary from the at least one external service and the at least one user context.
